(19) United States
(12) Patent Application Publication
(10) Pub. No.: US 2005/0129832 A1
(43) Pub. Date: Jun. 16, 2005

(54) Bean germ extracts

(76) Inventor: Roger C. Hammond, Brooksville, KY (US)

Correspondence Address: FROST BROWN TODD, LLC, 2200 PNC CENTER, 201 E. FIFTH STREET, CINCINNATI, OH, 45202, US

(21) Appl. No.: 11/000,802

(22) Filed: Dec. 1, 2004

Related U.S. Application Data
(60) Provisional application No. 60/529,030, filed on Dec. 12, 2003.

(51) Int. Cl. A23L 1/164

(52) U.S. Cl. 426/620

(57) ABSTRACT

This invention features a method for preparing an isoflavone-containing extract from bean germ. The method includes adding bean germ to water for a sufficient period of time (this mixture may be stirred) so as to separate soluble and insoluble materials from the bean germ to obtain an isoflavone-containing solution. The bean germ/water mixture has a temperature of from about 30° C. to about 99° C., and a pH of the isoelectric point of bean germ proteins.

### CROSS REFERENCE TO RELATED APPLICATION

The present invention is based upon and claims priority from U.S. Provisional Application Ser. No. 60/529,030, filed Dec. 12, 2003, incorporated by reference herein.

### TECHNICAL FIELD

The present invention relates to a process for making bean germ extracts, and particularly soybean germ extracts.

### BACKGROUND OF THE INVENTION

Soybeans are rich in isoflavones, which have been shown to possess anti-cancer activity. However, many people do not like food products made from soybeans because of their smell, taste, or texture. Thus, there exists a need to extract isoflavones from soybeans so that they can be taken as dietary supplements.

Extraction of isoflavones from soybeans typically requires removing soybean proteins. Several methods for removing soybean proteins have been reported. For example, after adjusting the pH of an aqueous soybean suspension, the soybean proteins can be precipitated and separated from other components. Coagulants, such as salts, can also be used to precipitate proteins from an aqueous soybean suspension.

### SUMMARY OF THE INVENTION

The present invention is based on the unexpected discovery that isoflavones can be easily extracted from soybean germ at a pH of the isoelectric point of soybean germ proteins. The resulting extract is sufficiently low in protein that, when used in food products, the protein does not cause solubility problems. At acceptable use levels, even in lightly flavored beverages, the extract has minimal or undetectable flavor, odor and color. Additionally, the resulting extract contains a range of phytonutrients, in addition to the isoflavones, such as saponins, oligosaccharides and phytic acid which may be of potential nutritional and commercial significance and value.

Thus, the present invention features a process for preparing an isoflavone-containing extract from bean germ, such as soybean, mung bean, black bean, and/or kidney bean germ. The process includes the step of contacting bean germ (either whole or pulverized) with water for a sufficient period of time so as to separate soluble and insoluble materials to obtain an isoflavone-containing solution. The bean germ/water mixture is kept at a pH of the isoelectric point of bean germ proteins (e.g., about 3.0-5.0 or about 3.5-4.5), and is preferably kept at a temperature of about 30-99° C. (e.g., about 50-80° C. or about 65-75° C.) throughout the entire process. The bean germ can be stirred in the water by a mechanical stirrer or by other suitable means, although stirring is not essential. For example, the bean germ can be placed in the water in a continuous flow process without stirring. The insoluble materials can be removed by filtration, centrifugation, decantation, or other suitable means.

The bean germ utilized may be in whole (non-pulverized) or pulverized form. Pulverized bean germ can be obtained by crushing the germ to grains of certain sizes. If pulverized, the bean germ should not be so small that the fines get into the extract and need to be removed. If pulverized, the bean germ can, for example, have an average particle size such that 70% of the particles are less than about 250 μm. The bean germ is placed in water at an elevated temperature to dissolve water-soluble isoflavones. The residence time is sufficient when most of the water-soluble isoflavones are dissolved, which can be determined empirically. The pH of the mixture is adjusted, using a suitable, preferably food grade, acidulant, to the isoelectric point of the bean germ proteins to minimize the solubility of those proteins. The isoelectric point of bean germ proteins is a pH at which those proteins have zero or near zero net electric charge and are therefore least water soluble. When practicing this method, one adjusts the pH of the bean germ/water mixture to the isoelectric point of bean germ proteins, i.e., the pH at which the net electric charge of proteins have minimum net zero charge, or to a pH within a margin of about ±0.5 (preferably ±0.3) pH units of that specific pH.

After sufficient residence time, one can remove the insoluble materials from the supernatant to obtain an isoflavone-containing solution. The insoluble materials include both the components of bean germ that are water-insoluble and those that are soluble in water at other pH values but become insoluble due to the pH adjustment. The isoflavone-containing solution thus obtained can be further concentrated by removing water to produce an extract in a dry form (e.g., a powder) or in a wet form (e.g., a concentrated solution).

The details of one or more embodiments of the invention are set forth in the description below. Other features, objects, and advantages of the invention will be apparent from the detailed description and from the claims.

### DETAILED DESCRIPTION OF THE INVENTION

An isoflavone-containing extract can be prepared, for example, by the following method: bean germ (either whole or pulverized) is placed in a container and immersed in water of an elevated temperature (e.g., 70° C.), to form a slurry. The temperature of the water will generally be less than its boiling point, although water under pressure at temperatures over 100° C. may be used. The germ may be stirred during the course of its immersion. The pH of the slurry is then adjusted to the isoelectric point of the bean germ proteins. This may be done by direct pH adjustment of the slurry, or one can adjust the pH of the water prior to immersing the germ in it by using sufficient titrant to reach the desired pH after the water comes into full contact with the germ. The slurry is maintained for a sufficient period of time to solubilize the bean germ isoflavones, which can be predetermined or determined during the slurrying step. The insoluble materials are allowed to settle in the container and then separated from the isoflavone-containing supernatant by decantation. One can also remove the insoluble materials by filtration or centrifugation to obtain an isoflavone-containing solution. The container is kept at an elevated temperature during the slurrying step and the removal of the insoluble materials.

In a preferred embodiment of batchwise extraction, the insoluble materials are extracted again following the procedures described above. The isoflavone-containing solution thus obtained is then combined with that obtained from the first extraction. The water in the combined isoflavone-containing solution can be evaporated to produce a concentrated or dried isoflavone-containing extract. A dried extract can also be prepared by other suitable drying methods, such as lyophilization or spray drying the concentrated extract using a suitable carrier (e.g., maltodextrin) as necessary. In a continuous extraction, the water is circulated or recirculated until a satisfactory extraction efficiency is attained.

To practice the method of this invention, a sufficient contact or immersion (or stirring, if used) time can be determined empirically. For example, one can compare the amount of water-soluble isoflavones in the bean germ with the amount of isoflavones that have been dissolved in the water and determine whether a satisfactory amount of the water-soluble isoflavones has been dissolved. The amount of isoflavones dissolved in the water can be determined by taking an aliquot and analyzing it. The contact/immersion time is considered sufficient when a satisfactory amount (fraction) of the isoflavones have been dissolved in the water. The contact/immersion time is also considered sufficient when the amount of the isoflavones dissolved in the water does not increase significantly further over time. Typically, the contact/immersion time will be between about 15 minutes and about 2 hours, preferably between about 30 and about 60 minutes. Materials known in the art to effect dissolution of the isoflavones may be added to the solution. See, for example, U.S. Pat. No. 6,458,406, Ono, et al., issued Oct. 1, 2002, and U.S. Published Application 2002/0048627 A1, Ono, et al., published Apr. 25, 2002, both incorporated by reference herein.

To determine the isoelectric point of bean germ proteins, one can measure the protein concentration of the supernatant at different pH values. The isoelectric point is the pH when the proteins are collectively least soluble or near least soluble in aqueous solution. The isoelectric point of proteins is often measured using the electrophoretic technique of isoelectric focusing (IEF). However, the empirical approach is effective here, when dealing with a mixture of naturally-occurring proteins. The protein concentration of the supernatant can be measured by UV-Vis Spectroscopy, or other suitable means. When practicing the method of this invention, the bean germ/water mixture can be kept at a pH when bean germ proteins are collectively least soluble.

An isoflavone-containing extract can be decolorized using techniques known in the art to remove any undesirable color during the process described above. For example, an isoflavone-containing solution can be decolorized before it is concentrated to form an isoflavone-containing extract. Examples of decolorizing methods known in the art include the use of activated carbon or bleaching earths. See e.g., in “Soybeans, Chemistry, Technology, and Utilization” by K. Liu, published by Aspen Publication, 1999.

An isoflavone-containing extract can be prepared using bean germ from a variety of beans as a starting material. For example, soybean germ, which contains the majority of the isoflavones of soybeans, can be extracted by the method described above. Commercially available soybean germ can be obtained from Acatris, (Minneapolis, Minn.) (for example, SoyLife Focus or SoyLife Complex) or from Cargill (Minneapolis, Minn.) (for example, Advanta Soy Complete). Examples of other bean germ which can be used include mung bean germ, black bean germ and kidney bean germ.

The method of this invention can be practiced as a batch process or a flow process, i.e., a continuous extraction and filtration process. Typically, flow processes are employed to help maintain reasonable manufacturing costs. When a flow process is used, stirring of the bean germ/water mixture is frequently not necessary.

The isoflavone-containing extract obtained by the method of the invention can be added to a food product either in a dried or wet form. The food product can be a solid, a paste, or a liquid food product, such as, but not limited to, milk, tea, soft drinks, juices, coffee, seasonings, cereals, water, beer, cookies, chewing gum, chocolate, or soups.

The isoflavone-containing extract can include extracts from two or more different beans or bean germs and can also include co-extracts from other grains, such as barley, rice, and malts. Additionally, the extract can be fortified with electrolytes (e.g., magnesium sulfate and potassium chloride), flavors, preservatives (e.g., ascorbic acid and propyl gallate), and other additives (e.g., vitamins and minerals).

Plant germs are known to be sources of desirable nutrients. The composition of various batches of the concentrate made by the present invention was determined by an independent laboratory.

Summary of the Chemical Product Analysis for 6 Batches of product

| | Manufacturing Batch | | | | | |
|---|---|---|---|---|---|---|
| Component | Batch 1 | Batch 2 | Batch 3 | Batch 4 | Batch 5 | Batch 6 |
| Total isoflavones (as is basis) | 10.04 | 9.96 | 10.32 | 9.61 | 9.66 | 10.48 |
| (mg/mL) | | | | | | |
| Ash (%) | 2.16 | 2.03 | 2.05 | 1.86 | 2.08 | 2.30 |
| Crude Fat (%) | 1.12 | 0.86 | 1.03 | 0.90 | 1.14 | 1.87 |
| Moisture (%) | 74.2 | 74.6 | 72.1 | 75.0 | 71.8 | 67.5 |
| Protein (%) | 2.45 | 2.81 | 2.97 | 2.47 | 2.84 | 3.46 |
| Carbohydrate, Total (%) | 13.3 | 13.3 | 15.0 | 13.9 | 15.7 | 17.4 |
| Fiber, Total Dietary (%) | <0.2 | <0.2 | <0.2 | 0.2 | 0.2 | <0.2 |
| Heavy metals (ppm as Pb)^{a} | <5 | <5 | <5 | <5 | <5 | <5 |
| Citric Acid (g/100 g) | 6.26 | 6.12 | 6.57 | 5.21 | 5.92 | 7.00 |

The range of isoflavones extracted from the soy germ by the process of the present invention mirror the distribution of the isoflavones present in soy germ. The isoflavones naturally present in soy germ are analyzed by HPLC after extraction into a solvent such as ethanol under conditions avoiding chemical changes during the extraction. A typical distribution is shown below.

Isoflavone distribution in soy germ

| Isoflavone | % |
|---|---|
| Daidzin | 29.2 |
| Glycitin | 25.1 |
| Acetyl Daidzin | 15.0 |
| Acetyl Glycitin | 12.0 |
| Genistin | 8.8 |
| Acetyl Genistin | 4.7 |
| Daidzein | 4.0 |
| Genistein | 1.2 |

The more water-soluble glycone forms of the native isoflavones also predominate in the extract of the present invention, as shown below.

Summary of the Isoflavone Distribution for 5 Batches of product

| | Manufacturing Batch | | | | |
|---|---|---|---|---|---|
| Isoflavone (%) | Batch 1 | Batch 2 | Batch 3 | Batch 4 | Batch 7 |
| Daidzin | 35.04 | 35.09 | 34.75 | 34.89 | 34.34 |
| Glycitin | 25.97 | 25.90 | 25.73 | 25.44 | 26.22 |
| Acetyl Daidzin | 18.99 | 19.01 | 19.17 | 19.23 | 18.81 |
| Acetyl Glycitin | 9.06 | 9.22 | 9.29 | 9.11 | 9.19 |
| Genistin | 6.69 | 6.67 | 6.70 | 6.65 | 6.72 |
| Acetyl Genistin | 3.63 | 3.53 | 3.65 | 3.66 | 3.60 |
| Daidzein | 0.60 | 0.59 | 0.65 | 1.00 | 1.03 |
| Genistein | 0.03 | 0 | 0.06 | 0 | 0 |

Malonyl derivatives were also present in both the raw soy germ and the extract, as indicated by LC-MS, but were not quantified since standards were not available.

Soybeans are known to be sources of carbohydrates and sugars, and of phytonutrients other than isoflavones. Although the presence and concentration of such components in the extract could not be anticipated because the distribution of such components between the soy germ and the cotyledon storage sites in soybeans is not fully established, it was established through analysis by an independent laboratory that the concentrated extract of the present invention contained levels of such nutrients and phytonutrients that may be physiologically significant. The results are shown below. The predominant phytonutrients present in the extract are the isoflavones.

Summary of the Results of the Carbohydrate Profile Analysis¹ for
6 Batches of product

| Carbohydrate | Manufacturing Batch | | | | | |
|---|---|---|---|---|---|---|
| (g/100 g) | Batch 1 | Batch 2 | Batch 3 | Batch 4 | Batch 5 | Batch 6 |
| Glucose + | 2.6 | 2.6 | 2.3 | 2.4 | 2.7 | 3.0 |
| fructose | | | | | | |
| Maltose | <0.2 | <0.2 | <0.2 | <0.2 | <0.2 | 0.6 |
| Maltotriose | 4.8 | 0.8 | 1.4 | <0.2 | 1.1 | 1.6 |
| Maltotetraose | 1.6 | 1.6 | 1.4 | 1.4 | 1.9 | 2.0 |
| Stachyose | 3.1 | 3.2 | 3.8 | 2.8 | 3.0 | 3.8 |
| Raffinose | <0.2 | <0.2 | <0.2 | <0.2 | <0.2 | <0.2 |

¹Analyses of the carbohydrate profile was performed using AOAC Method 977.20.

Summary of the Results of the Sugar Profile Analysis² for 6 Batches
of product

| | Manufacturing Batch | | | | | |
|---|---|---|---|---|---|---|
| Sugar (%) | Batch 1 | Batch 2 | Batch 3 | Batch 4 | Batch 5 | Batch 6 |
| Fructose | 1.74 | 1.56 | 1.5 | 1.46 | 1.72 | 1.92 |
| Glucose | 0.63 | 0.60 | 0.62 | 0.58 | 0.64 | 0.67 |
| Sucrose | 1.81 | 1.96 | 2.35 | 1.70 | 1.73 | 1.58 |
| Maltose | <0.20 | <0.20 | <0.20 | <0.20 | <0.20 | <0.2 |
| Lactose | <0.20 | <0.20 | <0.20 | <0.20 | <0.20 | <0.2 |

²Analyses of the sugar profile was performed using AOAC Method 982.14.

Summary of the Results of the Phytonutrient Product Analysis for
6 Lots of product

| | Manufacturing Batch | | | | | |
|---|---|---|---|---|---|---|
| Phytonutrient | Batch 1 | Batch 2 | Batch 3 | Batch 4 | Batch 5 | Batch 6 |
| Total Saponins | 0.087 | 0.076 | 0.085 | 0.191 | 0.100 | 0.199 |
| (mg/mL)^{a} | | | | | | |
| Phytic acid | 0.505 | 0.253 | 0.379 | 0.695 | 0.505 | 0.474 |
| (mg/g)^{b} | | | | | | |
| Trypsin | <2,000 | <2,000 | <2,000 | <2,000 | <2,000 | <2,000 |
| inhibitor | | | | | | |
| (TIU/g)^{c} | | | | | | |

^{a}For analysis of saponin levels in the product, the method of Hu et al. (2002) was used
^{b}The phytic acid levels in the product were measured using AOAC Method 986.11
^{c}Trypsin inhibitor levels were analyzed using AOCS Method Ba 12-75

Plant germs are known to be sources of vitamins. A sample of a concentrated soy germ extract of the present invention, containing about 10 mg isoflavones/mL, was analyzed by an independent laboratory. The results are reported below, along with a calculation of the proportion of the RDI/RDA that would be provided by an addition of this extract to provide 20 mg of isoflavones (2 mL).

B-VITAMIN CONTENT

| | Analyzed | | | | % RDI/RDA |
|---|---|---|---|---|---|
| Vitamin | Amount | Units | RDI | RDA | per 2 mL |
| Folic acid, total | 56.4 | μg/100 g | — | 0.4 mg | 0.3 |
| Niacin | 1.73 | mg/100 g | 20 mg | — | 0.2 |
| B6 | 0.251 | mg/100 g | 2 mg | — | 0.25 |

The extract contributes less than 1% of the RDI/RDA of these vitamins tested, when added to a foodstuff at a daily serving size of 20 mg of isoflavones.

DIETARY FIBER CONTENT

| | |
|---|---|
| Fiber, Dietary, Total | 0.2% |
| Fiber, Dietary, Insoluble | <0.2% |
| Fiber, Dietary, Soluble | 0.2% |

As expected, the extract is a source of soluble fiber, only.

The specific examples below are to be construed as merely illustrative, and not limiting of the remainder of the disclosure in any way whatsoever. Without further elaboration, it is believed that one skilled in the art can, based on the description herein, utilize the present invention to its fullest extent. All publications cited herein are hereby incorporated by reference in their entirety.

### EXAMPLE 1

925 mL of de-ionized water was heated to 70° C. in a mixing vessel equipped with an overhead stirrer with a propeller-type paddle. 75 g of soybean germ (SoyLife Focus, Batch #83H/1284/RG, Acatris) was added to the heated water and the mixture was stirred to form a slurry. The pH of the slurry was measured using a pH electrode with integral thermal compensation. A total of 8 g of citric acid was added in aliquots to adjust the pH to 3.75. The slurry was stirred for 30 minutes. The stirrer was then switched off and the insoluble materials were allowed to settle for 15-30 minutes. The supernatant was decanted into a second mixing vessel maintained at 70° C. 575 g of supernatant was recovered (Extract #1).

The isoelectric point was determined using a practical approach. The objective was to find a pH at which protein haze was minimal. The first set of studies involved observation of settling rate of the insolubles and clarity of the supernatant (at 70° C., standard conditions), at pH's 5.00, 4.00, 3.50 and 3.00, which were achieved by successive additions of citric acid, stirring to dissolve, and allowing to settle. Visual observation suggested 3.50-4.00 was an effective range. A further study was done at a range of pH values and the minimum protein concentration confirmed at about 3.75 by using a Lowry protein assay. This is described in a further Example.

Extract #2 was prepared from the insoluble materials and the remaining supernatant from the first extraction. The insoluble materials were re-extracted by adding 575 g of de-ionized water to the first mixing vessel. The mixture was stirred at 70° C. for 30 minutes. The stirrer was then switched off and the insoluble materials were allowed to settle for 15-30 minutes.

35 g of Celite #560 was added to Extract #1. The mixture was stirred to form a suspension. The suspension was then vacuum-filtered through a 150 mm diameter Buchner funnel with #4 Whatman filter paper. Extract #2 was also vacuum-filtered through the Celite bed thus formed on the Buchner funnel at 70° C. 1250 g of soybean germ extract filtrate was collected and subsequently concentrated via vacuum distillation at 40 mm Hg to obtain a concentrated extract (83.3 g solution). The concentrated extract after evaporation was a clear solution at approximately 70° C., but on cooling to room temperature or below, a precipitate was formed which could be redissolved by heating again to about 70° C.

Each gram of the concentrated extract contained 19.5 milligram of isoflavones. The water-soluble glycone forms of the isoflavones represented about 95% of the extracted isoflavones.

Soy extracts were analyzed using a 2695 Waters Alliance HPLC system. The sample size injected was 3 μL, and UV absorbance at 260 nm was monitored with a Waters 2996 Photodiode Array Detector. The separation of the individual isoflavones was accomplished using a reverse phase C18 column (3.9×75 mm, 4 mm particle size Symmetry, Waters Corporation) The solvent system consisted of 0.1% acetic acid in water (A) and acetonitrile (B). Elution was carried out at a flowrate of 0.8 mL/min. using a mobile phase consisting of 90% A and 10% B at initial condition and going to 65% A and 35% B in 20 minutes using a linear gradient.

Standard Preparation—

Reference standards for daidzin, genistin, glycitin, genistein, acetyl daidzin, acetyl genistin and acetyl glycitin were obtained from LC Laboratories. Stock solutions of each isoflavone were prepared containing 0.2 mg/mL in ethanol. A standard working solution was prepared taking 1 mL of each stock solution and diluting to 10 mL with ethanol. Response factors were calculated for each isoflavone and used for quantification of the samples.

Sample Preparation—

Powder samples were extracted using 80% v/v ethanolic solution and sonicated for 30 minutes. Liquid samples were filtered and injected directly.

The spent soy germ sludge after isoflavone extraction may be homogenized with ethanol for bulk soysaponin extraction.

### EXAMPLE 2

Extraction and Filtration—

Soy germ flour (32 lbs.) was dispersed in 392 lbs. of prewarmed (about 70° C.) deionized water in a 50 gal. Groen stirred kettle mounted on load cells and equipped with a jacket used to maintain temperature. The pH was adjusted to 3.75±0.1 by the addition of 3 lbs. citric acid, using a combination pH probe with an integral temperature compensation probe. Stirring to maintain the flour in suspension and heating to maintain the temperature were continued for 30 minutes. The stirrer was then stopped and the solids allowed to settle. After approximately 30 minutes, the relatively clear supernatant was removed by suction and polished by filtration through a 100 μm bag filter and further filtration through a bed of Celite 560 on a 36″ vacuum Buchner funnel. The filtration was carried out at a rate sufficient to avoid significant cooling of the extract until it reached the vacuum receiver. The contents of the vacuum receiver were transferred to a 200 gal. jacketed Groen kettle mounted on load cells, equipped with a stirrer and maintained at about 70° C. This was termed Extract 1. A total of approximately 200 lbs. of the supernatant, after settling, was removed and filtered. This represented approximately 50% of the water added. The solids remaining in the kettle were extracted with a further batch of deionized water equal in weight to Extract 1. After the required weight of water was added to the kettle, the temperature was raised to about 70° C. and the pH checked. No further addition of citric acid was necessary. After 30 minutes extraction under stirring and 30 minutes settling without stirring, the extract was filtered as described for Extract 1. The slurry was dewatered on the Buchner funnel as thoroughly as possible, consistent with maintaining the temperature. This extract was designated Extract 2 and was combined with Extract 1 from the same batch in the 200 gal. Groen kettle.

Concentration—

Concentration was carried out using a Pfaudler Wiped Film Evaporator (WFE 4.2 ft.², 316 L stainless steel, Teflon™ wiper blades). Conditions were adjusted to give an evaporation rate of approximately 2 lb./min. and relatively cool evaporation surface temperature. The vacuum applied was approximately 24″ Hg.

The combined extract from the 200 gal. Groen kettle was fed by aspiration to the WFE and the concentrate recycled to the kettle. The distillate was discarded. Concentration was continued until the kettle weight indicated a 10-fold concentration had been achieved. The temperature of the kettle was maintained at about 70° C. throughout the concentration.

On conclusion of concentration, the concentrate was packed into 6-gal. plastic pails which had been rinsed with ethanol for sanitation and thoroughly drained. Pails were stored under refrigeration.

### EXAMPLE 3

250 Kg of SoyLife Focus Unmilled (Acatris, Minneapolis, Minn., 1.5% total isoflavones) were charged into a Schrader extractor. In a separate tank, 2500 Kg of reverse osmosis treated water and 16.75 Kg of citric acid was warmed to 75° C. by recirculation through a plate-and-frame heat exchanger. The warmed solution was passed through the heat exchanger and then through the Schrader extractor by upward flow at a flow rate of 4000 L/h, then returning to the tank. During 2 hours of recirculation, the temperature was maintained at 74-76° C. and the pH was stable at 3.63-3.7. After recirculation was stopped, the warm extract was filtered through a 25 μm bag filter to remove fines. The total isoflavone concentration was 1.3 mg/mL in the 2200 L of extract obtained (extraction yield of 76% from the soy germ). The extract was concentrated in the Schrader two-stage vacuum evaporator at a vacuum of approximately 27 inches of mercury until a concentrate of approximately 305 Kg was obtained at the minimum working volume of the still. The total isoflavone in the concentrate was 7.3 mg/mL.

### EXAMPLE 4

### Determination of pH that Provides for Minimal Protein Extraction During the Soy Germ Extraction Process

To determine the optimal pH for extraction that minimizes protein dissolution during the aqueous extraction of isoflavones from the soy germ, an experimental extraction was conducted whereby soy germs were dispersed in warm water, successive aliquots of citric acid were added to achieve desired pH levels, and the pH being allowed to equilibrate. At each pH level, a sample of the liquid extract was removed, filtered and subjected to a standard protein assay.

Thus, 75 g of SoyLife FOCUS® Unmilled (Batch 54G/1309/F) were stirred with 925 mL of deionized water in a beaker with an overhead stirrer and temperature-compensated pH probe, the whole beaker assembly being placed in a temperature controlled water bath at 72° C. After equilibration, a 5 mL sample was removed and filtered through a 0.45 μm ACRODISC® (to remove particulates, and the pH recorded (pH 6.07). An aliquot of solid citric acid was added, sufficient to lower the pH to 5.27 after equilibration. A sample was removed in the same way as previously, another aliquot of citric acid was added and the process repeated until a range of samples at successively lower pH values had been obtained.

1 mL subsamples of these extract samples were subjected to standard Lowry protein assay (Sigma Protein Assay Kit P 5656), after TCA precipitation of the protein and removal of the supernatant to avoid any interference by polyphenols such as isoflavones. It was visually apparent that the lowest protein concentration was at about pH 3.75. The absorbance at 650 nm was measured and the minimum protein solubilization was apparent from the data obtained.

These data are summarized in the following table:

Effect of pH on protein extraction from soy germ

| Sample # | pH | Folin assay (1 mL sample/650 nm) |
|---|---|---|
| 1 | 6.07 | 0.8845 |
| 2 | 5.27 | 1.1691 |
| 3 | 4.67 | 1.1781 |
| 4 | 4.24 | 1.1794 |
| 5 | 4.02 | 1.1424 |
| 6 | 3.73 | 1.0095 |
| 7 | 3.52 | 1.3342 |
| 8 | 3.16 | 1.6008 |
| 9 | 2.78 | 1.9534 |

### OTHER EMBODIMENTS

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

From the above description, one skilled in the art can easily ascertain the essential characteristics of the present invention, and without departing from the spirit and scope thereof, can make various changes and modifications of the invention to adapt it to various usages and conditions. Thus, other embodiments are also within the scope of the following claims.

1. A method for preparing an isoflavone-containing extract from bean germ, comprising:
contacting bean germ with water for a sufficient period of time so as to separate soluble and insoluble materials from said bean germ thereby obtaining an isoflavone-containing solution;
wherein the bean germ/water mixture has a temperature of from about 30° C. to about 99° C. and a pH of about the isoelectric point of bean germ proteins.

2. The method of claim 1, wherein the bean germ is selected from soybean germ, mung bean germ, black bean germ, kidney bean germ, and mixtures thereof.

3. The method of claim 2, wherein the bean germ is pulverized.

4. The method of claim 3, wherein the bean germ is soybean germ.

5. The method of claim 4, wherein the bean germ/water mixture has a pH of from about 3.0 to about 5.0.

6. The method of claim 5, wherein the temperature of the bean germ/water mixture is from about 50° C. to about 80° C.

7. The method of claim 6, wherein the pH of the bean germ/water mixture is about 3.75.

8. The method of claim 7, wherein the temperature of the bean germ/water mixture is about 70° C.

9. The method of claim 8, wherein the contacting step takes place for about 30 to about 60 minutes.

10. The method of claim 1, further comprising removing insoluble material from the isoflavone-containing solution.

11. The method of claim 1, further comprising evaporating the water from the isoflavone-containing solution to obtain a concentrated or dried isoflavone-containing extract.

12. The method of claim 1, wherein the temperature of the bean germ/water mixture is from about 50° C. to about 80° C.

13. The method of claim 12, wherein the temperature of the bean germ/water mixture is from about 65° C. to about 75° C.

14. The method of claim 1, wherein the pH of the bean germ/water mixture is from about 3.0 to about 5.0.

15. The method of claim 14, wherein the pH of the bean germ/water mixture is from about 3.5 to about 4.5.

16. The method of claim 1, wherein the mixture of bean germ and water is stirred.

17. The method of claim 1, carried out as a continuous flow process.

18. The method of claim 4, wherein the isoflavone-containing extract additionally contains phytonutrients derived from the soy germ.

19. The product made by the process of claim 1.

20. The product made by the process of claim 3.

21. The product made by the process of claim 7.

22. The product made by the process of claim 10.

23. The product made by the process of claim 11.

24. The product made by the process of claim 1 wherein the isoflavone-containing extract additionally contains phytonutrients derived from the bean germ.
